(19) United States
(12) Patent Application Publication
(10) Pub. No.: US 2019/0364871 A1
(43) Pub. Date: Dec. 5, 2019

(54) ARTHROPOD TRAPPING APPARATUS AND METHOD

(71) Applicant: SemiosBio Technologies Inc., Vancouver (CA)

(72) Inventors: Jordan R. Hazell, Dunnville (CA); Eduardo T. Cunha, Vancouver (CA); Michael Gilbert, Vancouver (CA)

(21) Appl. No.: 16/427,306

(22) Filed: May 30, 2019

Related U.S. Application Data
(60) Provisional application No. 62/678,805, filed on May 31, 2018.

(51) Int. Cl. A01M 1/02; A01M 1/14; A01M 1/20; A01M 1/10

(52) U.S. Cl. CPC A01M 1/026; A01M 1/023; A01M 1/10; A01M 1/2038; A01M 1/2005; A01M 1/14

(57) ABSTRACT

An arthropod trap with an aerosol dispenser that is remotely controllable to dispense spray doses of an active ingredient such as a pheromone or other semiochemical. Images are captured of trapping media within the trap and are wirelessly communicated to a remote server or application. The dispenser is preferably upside down with the nozzle near the lower extremity of the inverted dispenser. An actuation mechanism controls the spray dose according to a schedule or according to individual sprays commands, each of which may be received wirelessly by the trap. Images of the trapping media may be used as feedback for verifying or modifying the metered dosing schedule.

### FIELD OF THE INVENTION

This invention relates to arthropod traps for monitoring arthropod populations and behavior.

### BACKGROUND OF THE INVENTION

It is known to use lures to attract arthropods into a trap housing which typically contains a trapping material such as a liquid or sticky surface which ultimately traps the arthropod. These traps are then periodically serviced, at which point target individuals are counted, trapping material are refreshed, and lures are replaced. Counts in the traps are used to estimate a given arthropod population density. In many cases, threshold numbers of target species per trap over a period of time leads to the application of a pesticide. The traps may also be used to assess the effect of mating disruptors, the environment and other pest behavior.

Commercially available forms of lures used in prior art traps rely on the passive and gradual release of active ingredients into the environment. The most commonly used technology in perennial tree crop agriculture is a septa lure comprising a piece of rubber that is impregnated with the desired active ingredients as lures. Due to the nature of this technology, daily release rates are dictated by temperature, age, as well as an array of environmental and manufacturing factors (Knight and Light, 2012; Liu et al., 2016). There is a decaying release rate over time (strong emission at the beginning, low emission by the end of life), and they only last 6-8 weeks which requires manual replacement. Trap counts later in a standard lure's lifetime will be lower than at the beginning due to less lure pheromone being emitted. With such environmental and age-related factors having an impact on the release rate on any given day, discrepancies due to release rate instability of a given lure pose a risk of inaccurate assessments of population densities as the pests' response to attractive compounds have been observed to be dose dependent (Liu et al., 2016). These potential misinterpretations, based on a variable trapping efficiency can lead to inaccurate assessments of population densities. This can ultimately lead to significant crop losses or the excessive use of pesticides.

It is therefore an object of this invention to provide an arthropod trap that enables the accurate assessment of arthropod populations or behavior, which is effectively free of the incorrect assumption that the arthropod response to passive release lures is equal under all environmental conditions and age.

These and other objects will be better understood by reference to this application as a whole. Not all of the objects are necessarily met by all embodiments of the invention described below or by the invention defined by each of the claims.

### SUMMARY OF THE INVENTION

A trap according to the invention includes a housing with an enclosure having access openings, a trapping media within the enclosure, imaging apparatus for imaging the media, a power unit and a communications module enabling wireless communication between the trap and a remote server. An aerosol dispenser equipped for remote metered dose actuation is housed in the trap. The dispenser is preferably mounted upside down, with a nozzle at a lower extremity of the dispenser and an actuation mechanism adjacent the nozzle. Preferably a tab is disposed proximal to the nozzle for receiving substantially all of the aerosol dose which impregnates the tab.

The trap may be operated remotely and wirelessly to download aerosol dose schedules and imaging schedules as a function of parameters that may include the type of arthropod of interest, the time of day, the season, environmental factors, the type of active ingredient being emitted from the aerosol or otherwise present in the environment and other such factors. The trap may also be controlled remotely to actuate individual doses and imaging. Imagery from the imaging apparatus may be used to provide feedback as to the effectiveness of the dosing schedule and to adjust the dosing schedule as necessary.

In one aspect the invention is an arthropod trap comprising an enclosure forming a cavity within the enclosure and openings in the enclosure for enabling arthropods to access the cavity. A trapping media, preferably a sticky media board, is retained within the enclosure. The enclosure also has imaging apparatus positioned to image the sticky media, a power unit, a controller (for example a microcontroller) and a communications module enabling wireless communication between the trap and a remote server. The module and the controller are configured to receive a schedule of metered releases of an active ingredient or individual actuation commands for dispensing the active ingredient. The trap further comprises an aerosol dispenser and actuation mechanism configured to cause the dispenser to spray a predetermined dose of the active ingredient. The actuation mechanism actuates a spray of the dose according to one of the schedule that was downloaded wirelessly to the trap or an individual actuation command, each having been received from the communications module.

In a more particular aspect, the aerosol dispenser is mounted upside down, with a nozzle at a lower extremity of the dispenser, the nozzle being directed toward the cavity. The actuation mechanism is adjacent the nozzle.

In another particular aspect, the trap may further comprise a tab disposed proximal to the nozzle for causing substantially all of the sprayed dose to be impregnated on the tab.

In another aspect the invention is a method for causing the emission from a trap of an active ingredient affecting the behavior of arthropods. The method comprises providing such a trap with an aerosol dispenser and an actuating mechanism configured to cause the dispenser to spray a predetermined dose of the active ingredient within the trap with each spray. The dispenser is configured to actuate a spray in response to one of a signal from a controller located within the trap (and operating according to a schedule received from a wireless communications module) and a wireless signal received by the communications module within the trap. A sticky media within the trap is periodically imaged. The resulting images are wirelessly communicated to a remote server or application.

In a more particular aspect, the schedule is created as a function of a parameter selected from among the group of parameters comprising: a species of arthropod of interest, a time of day, a season, environmental factors, a type of said active ingredient, an active ingredient present in the environment, an assessment of images received from the trap as a result of the operation of a prior schedule.

In an aspect the invention is an arthropod trap comprising a housing, a dispenser configured to store and dispense an active ingredient comprising an arthropod lure, a dose release mechanism for actuating a sprayed dose of the active ingredient from the pressurized dispenser, wherein the mechanism is configured to receive an active ingredient release signal from a controller within the housing, a trapping media for trapping arthropods, a camera for imaging the trapping media and a wireless communications module. The dispenser may be a pressurized aerosol dispenser and the dose may be a metered dose. A removable tab may be configured to be impregnated with the active ingredient from the dispenser. Preferably, the tab is aligned with, and disposed sufficiently close to, a nozzle of the dispenser so as to be impregnated with substantially all of the dose.

In a more particular aspect, the dispenser is mounted within the housing such that its nozzle is located at a lower extremity of the dispenser.

The trap may further comprise a sensor for detecting the presence of a spray from the dispenser. Preferably, a compartment housing the dispenser includes an aperture through which the spray may pass, and an inclined surface for mounting the tab thereon. The tab may be porous or have a 3D mesh-like or reticulated structure. It may have a step-like shape.

In another aspect the invention is a method for operating a remotely controlled arthropod trap, the trap comprising an imaging apparatus. The method comprises:
wirelessly communicating to the trap instructions for the metered release of an active ingredient affecting the behavior of arthropods;
the trap providing a signal to a metered actuating mechanism for dispensing a dose of the active ingredient in the trap by aerosol dispenser according to the instructions;
periodically capturing an image of captured arthropods; and,
wirelessly communicating the images from the trap.

The method may further comprise directing the dose by spray to a tab, substantially all of the dose being impregnated on the tab. The instructions may comprise a schedule for the metered releases of the active ingredient from the aerosol dispenser. The instructions may comprise a command to actuate a single spray of the dose. The schedule may be a function of a type of arthropod of interest, a time of day, a season, environmental factors, a type of active ingredient being emitted from the aerosol, a type of active ingredient present in the environment.

In another aspect the invention is an arthropod trap comprising an enclosure forming a cavity within the enclosure and openings in the enclosure enabling arthropods to access the cavity, a sticky media retained within the enclosure, imaging apparatus positioned with the enclosure for imaging the sticky media, a power unit, a controller and a communications module enabling wireless communication between the trap and a remote server and configured to receive a schedule of metered releases of an active ingredient. The trap further comprises an aerosol dispenser and actuation mechanism configured to cause the dispenser to spray a predetermined dose of the active ingredient according to the schedule or a command received from the communications module. The aerosol dispenser may be mounted upside down, with a nozzle at a lower extremity of the dispenser the nozzle being directed toward the cavity, with the actuation mechanism being adjacent the nozzle.

A tab may be disposed close to said nozzle for causing substantially all of the dose to be impregnated on the tab.

In another aspect the invention is a method of causing the emission from a trap of an active ingredient affecting the behavior of arthropods. The method comprises:
providing such trap with an aerosol dispenser and an actuating mechanism configured to cause the dispenser to spray a predetermined dose of the active ingredient within the trap with each spray;
the dispenser being configured to actuate a spray in response to one of:
a signal from a controller located within the trap the controller generating the signal according to a schedule received from a wireless communications module located in the trap; and,
a wireless signal received by the communications module within the trap; and,
periodically imaging a sticky media within the trap and wirelessly communicating the resulting images to a remote server or application.

The schedule may be created as a function of a parameter selected from among the group of parameters comprising: a species of arthropod of interest, a time of day, a season, environmental factors, a type of said active ingredient, an active ingredient present in the environment, an assessment of images received from said trap as a result of the operation of another schedule. There may be an additional step of processing the resulting images to derive an arthropod count. That step may be conducted by said server or application. An agronomic decision, such as the decision to spray a pesticide may be made as a function of the count.

The foregoing may cover only some of the aspects of the invention. Other and sometimes more particular aspects of the invention will be appreciated by reference to the following description of at least one preferred mode for carrying out the invention in terms of one or more examples. The following mode(s) for carrying out the invention are not a definition of the invention itself, but are only example(s) that embody the inventive features of the invention.

### BRIEF DESCRIPTION OF THE DRAWINGS

At least one mode for carrying out the invention in terms of one or more examples will be described by reference to the drawings thereof in which:

FIG. 1 is a left side perspective view of the arthropod trap according to the preferred embodiment;

FIG. 2 is a right side perspective view of the trap;

FIG. 3 is a left side bottom perspective view of the trap;

FIG. 4 is a right side bottom perspective view of the trap;

FIG. 5 is a perspective view of a shield side plate;

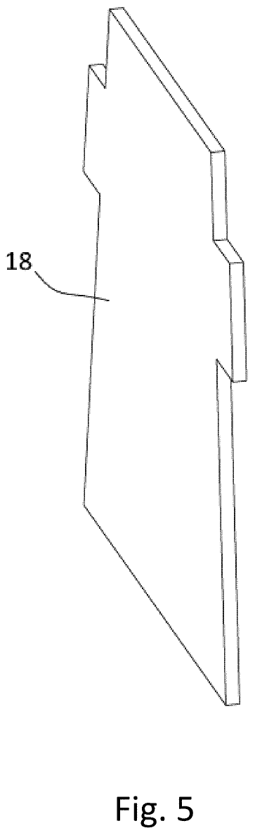

FIG. 6 is a perspective view of an upper housing portion of the trap;

FIG. 7 is a side perspective view of the lure tab;

FIG. 8 is a perspective cross-sectional view of the trap;

FIG. 9 is a view along lines 9-9 of FIG. 8 with the shield side plates omitted;

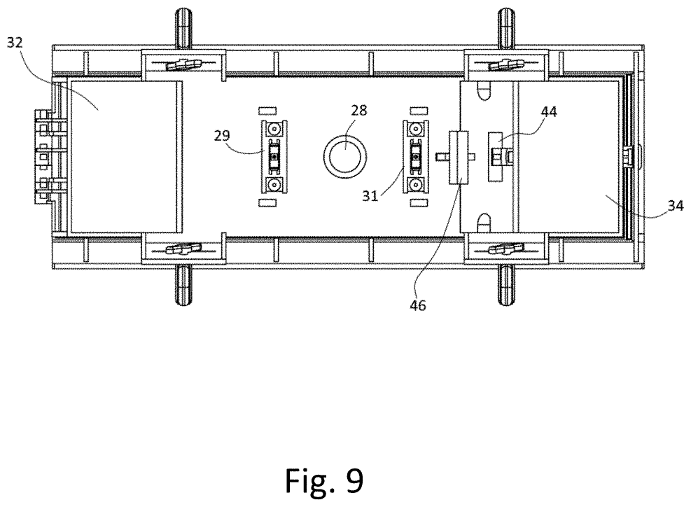

FIG. 10 is a bottom perspective view of the upper housing and further including the power unit compartment, the dispenser compartment, the optics platform and the printed circuit board;

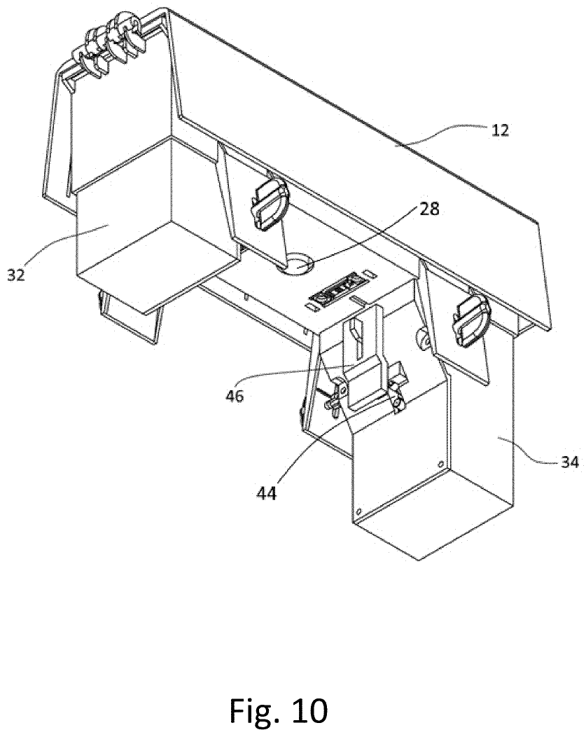

FIG. 11 is an exploded view of the dispenser compartment;

FIG. 12 is an illustration of the trap, gateway, remote serve and database associated with the preferred embodiment; and,

FIG. 13 is a graphical comparison of the release rates achievable by the prior art and by the preferred embodiment of the invention.

### DETAILED DESCRIPTION OF AT LEAST ONE MODE FOR CARRYING OUT THE INVENTION IN TERMS OF EXAMPLE(S)

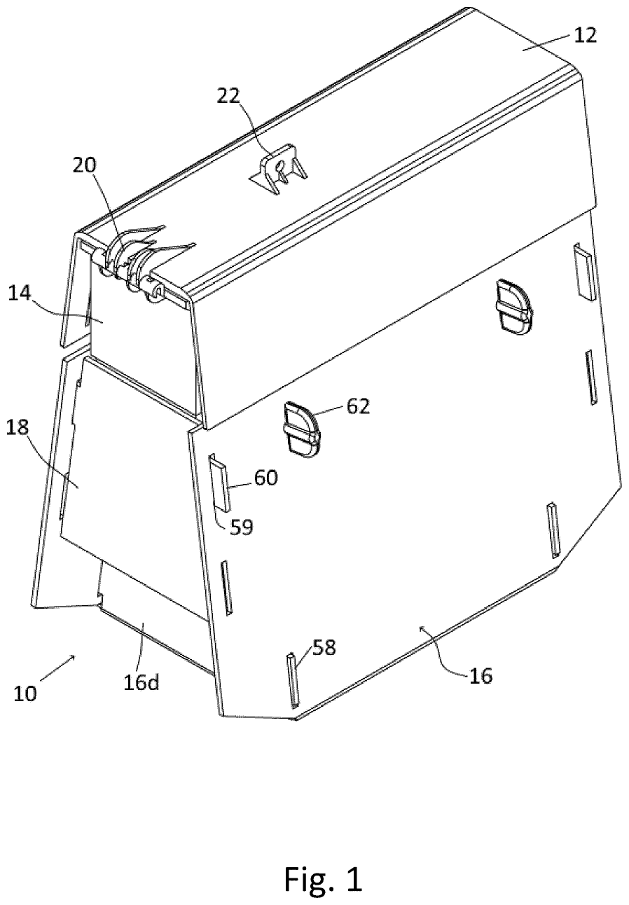

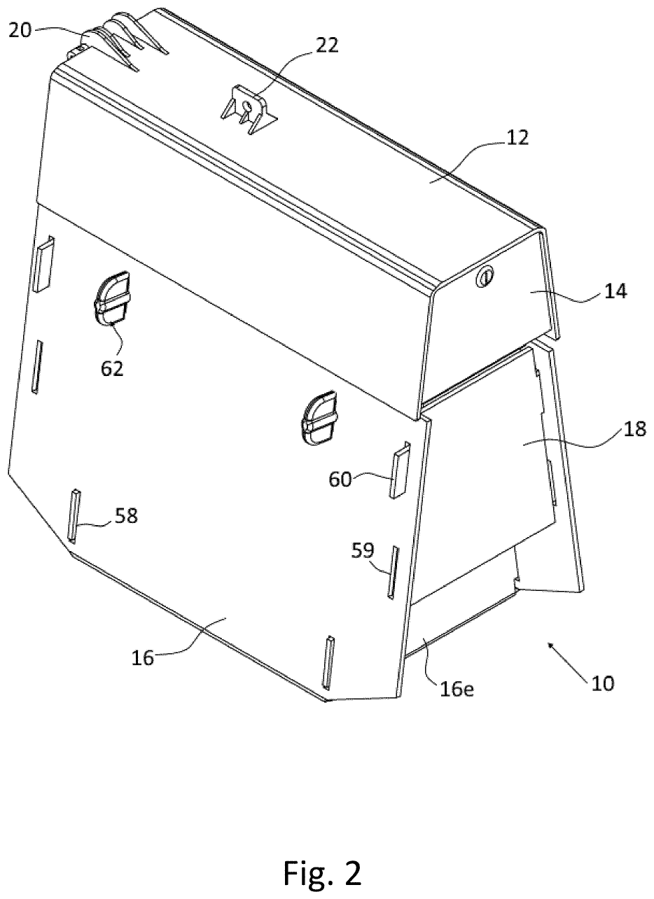

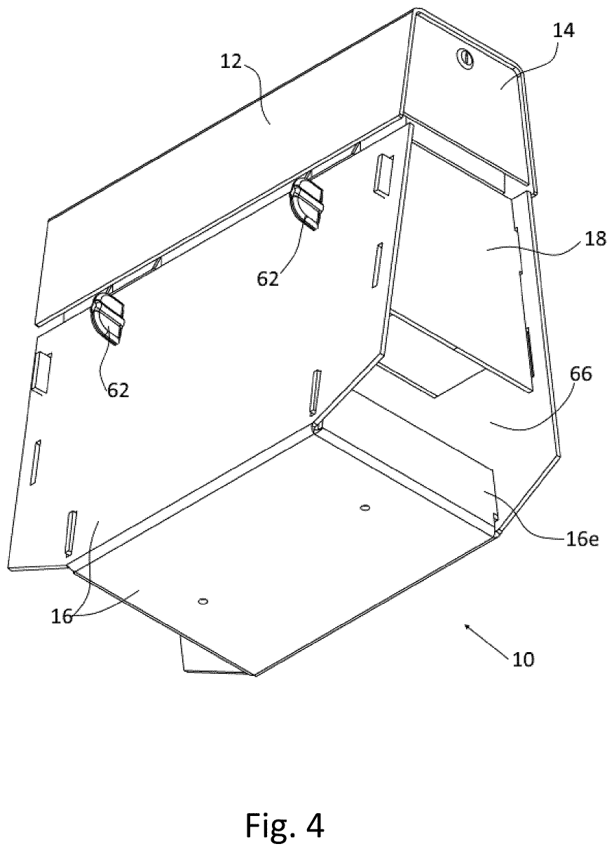

FIGS. 1-4 are the exterior views of an arthropod trap 10 according to the preferred embodiment. The trap comprises generally a housing comprising an upper housing 14 and its cover 12, an enclosure body 16 and shield side plates 18. Hinge fastening means 20 are provided to attach the cover 12 to the upper housing 14. The top surface of the cover 12 comprises an attachment means such as a lug, a hook or a loop 22, which allows the trap 10 to be hung, for example from a branch of a shrub or tree.

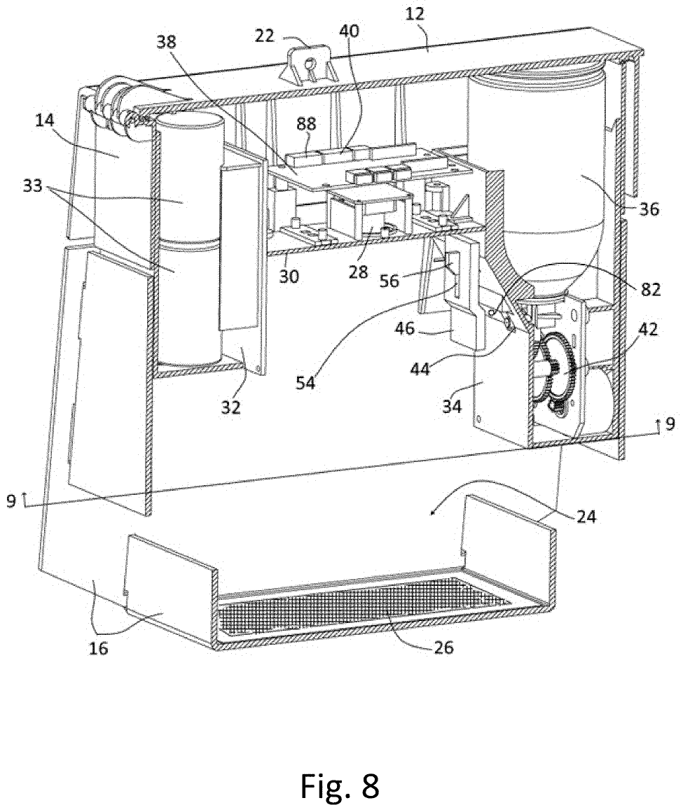

Referring to FIG. 8, the enclosure body 16 of the trap provides a cavity 24 into which insects and other arthropods may fly. The cavity also includes a sticky media board 26 as a trapping media intended to trap the arthropods. The board 26 is installed horizontally so as to be imaged by a camera 28 that is mounted on an optics platform 30 in the upper housing 14 part of the trap. The trap further includes a power unit compartment 32 (containing batteries 33 in the preferred embodiment) and an aerosol dispenser compartment 34. The preferred aerosol dispenser is a pressurized aerosol spray canister 36 configured to store and dispense by spray a predetermined dose of an active ingredient (for example an arthropod lure) with each spray.

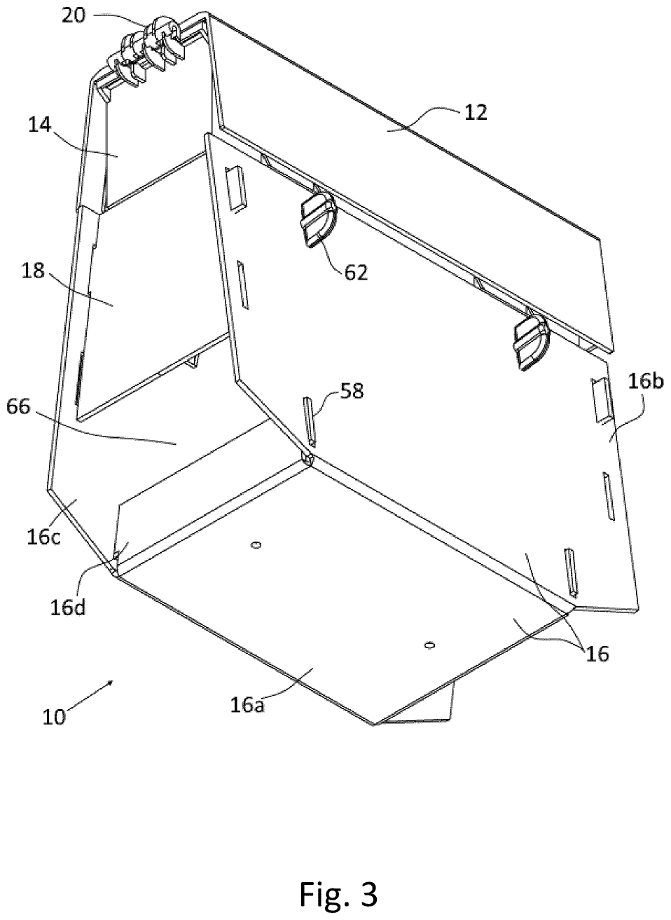

Referring now to FIG. 3, the enclosure body 16 comprises a base 16a and two opposed side walls 16b, 16c foldable up from the base 16a. End tabs 16d and 16e are also foldable up from the base 16a. Side walls 16b and 16c comprise slots 58 for receiving the end tabs 16d and 16e, slots 59 for receiving tabs 60 of the shield side plates 18, and slots (not seen separately) for receiving retention pins 62. The side walls 16b, 16c are folded up from the base 16a and the end tabs 16d, 16e are folded up and secured in the slots 58. Shield side plates 18 are secured to the side walls 16b and 16c. The shield side plates 18 do not extend downward to the level of the base 16a so as to leave gaps on each side of the trap as openings 66 for access of the arthropods into the cavity 24 formed by the enclosure body 16 and the shield side plates 18.

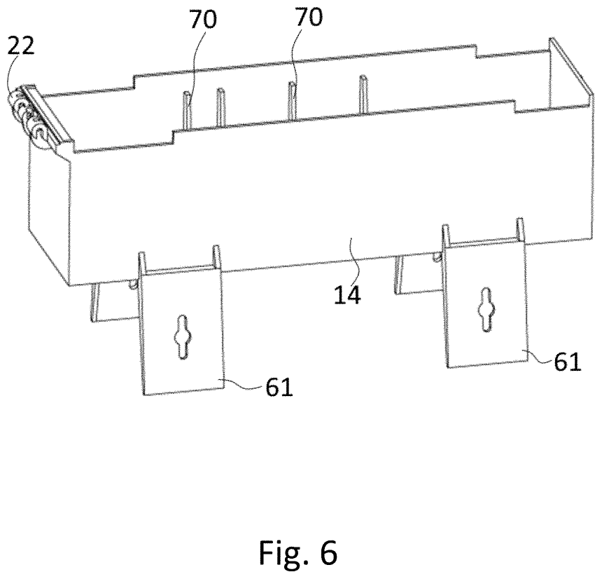

The upper housing 14 is shown more fully in FIG. 6. The upper housing 14 is installed at the top of the cavity 24 and is attached to the enclosure body 16 by means of retention pins 62 engaged on flaps 61. Cover 12 wraps around the upper housing 14 to which it is hingedly connected by hinge 20.

A printed circuit board 38 and its associated components sits atop the optics platform 30 and includes a wireless communications radio and module 40. The optics platform 30 supports a camera 28 and two LEDs 29, 31 on either side of the camera 28. The camera 28 is used to periodically image the sticky media 26 and to communicate the images to the microcontroller 88 for eventual wireless communication of the images to a remote server (which may be an application) 52. The LEDs illuminate the trapping media 26 during imaging by the camera 28.

The power unit compartment 32 is mounted opposite the dispenser compartment 34 in the upper housing 14. This separates the relatively heavy power unit and dispenser components. The batteries 33 are preferably oriented vertically as seen in FIG. 8 to allow the location of the printed circuit board 38 and the optics platform 30 in the middle of the upper housing 14.

In operation, the trap 10 is suspended in a monitoring area such as an agricultural production site. Under wireless control communicated to the trap 10 via the communications module 40, an actuation mechanism 42 (a metered dose release mechanism) housed in the dispenser compartment 34 causes a metered dose of spray to be emitted from the spray canister 36 (the actuation mechanism 42 may alternatively also be configured to control the amount of the dose, for example how long the spray nozzle is kept open). The spray is of an active ingredient or arthropod lure such as a synthetic pheromone or other suitable semiochemical that affects the behavior of arthropods or of the species of arthropod being monitored. The spray is directed generally into the cavity 24 of the trap, passing through an aperture 44 in the dispenser compartment, but according to the preferred embodiment the spray is intercepted by a lure tab 46 which is then impregnated with the active ingredient as will be described below.

Arthropods fly into the cavity and if they land on the sticky media 26, they are trapped in the media. The camera 28 images the sticky media periodically and transmits the images wireless to a local hub trap or to a gateway 50 for forwarding to a remote server 52 or application for data collection and analysis.

Referring again to the attachment means (loop 22 in the preferred embodiment), the attachment means is offset from the longitudinal center of the cover 12, toward the heavier power unit compartment 32. The overall trap loses mass each time the dispenser 36 emits the active ingredient thereby changing the center of gravity of the trap 10. The offset location of the attachment means 22 is optimized to take into account the loss of mass from the dispenser and the relatively heavier mass of the power unit (batteries 33).

The pressurized aerosol canister 36 has a spray nozzle 64. A traditional aerosol canister contains a “dip tube”, namely a straw which allows the can to be sprayed upright, drawing up liquid from the bottom of the container to the valve. In a trap with a relatively small footprint, installing an aerosol canister in a normal right-side up orientation places the spray nozzle at the top of the trap. In order to have the nozzle direct the spray into the center of the trap cavity 24, the body of the canister 36 would need to be to one side of the trap enclosure. In such configuration the body of the canister must extend down the side of the trap which would block access of arthropods through the openings 66 below the shield side plates 18. According to the invention, the canister is mounted in an upside down orientation in the dispenser compartment, with the spray nozzle 64 at the lower extremity 72 of the canister 36. In this orientation, the nozzle 64 is located about mid-height in the trap cavity 24 and the spray nozzle 64 is aligned to spray toward and into the cavity 24 through aperture 44. The metered release actuation mechanism 42 is adjacent the nozzle 64.

The inventors have found that trapping efficiency is better for some arthropods with a focused source emitter rather than with broad dispersal emitters. To make the active ingredient useful while also providing a non-dispersive source, a removable lure tab 46 preferably sits directly in front of the line of spray of the active ingredient. The active ingredient, for example, in the form of aerosol sprays directly onto this narrow lure tab, re-loading its surface with the pheromone. The tab 46 then effectively acts as a point source rather than an aerosol dispersal, emitting pheromone from an absorbent, adsorbent or porous material used for the lure receiving surface of the lure tab.

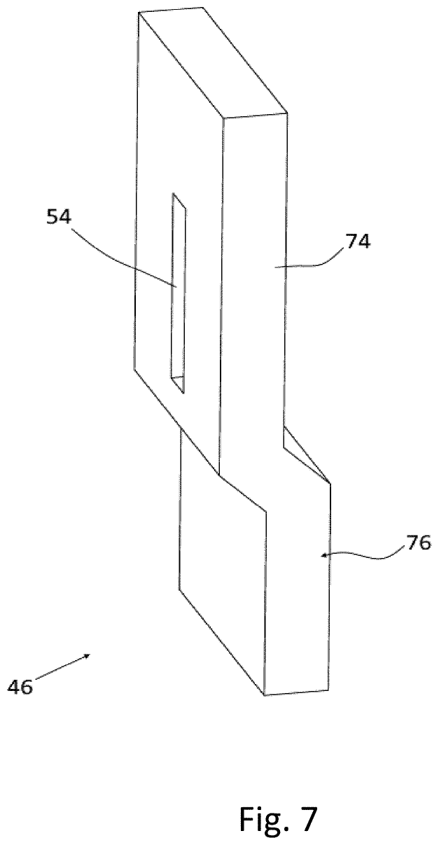

The removable lure tab 46 may be disposed in front of the pressurized dispenser, aligned with the nozzle 64 and close enough to the aperture 44 that the spray is substantially received by and impregnates the lure tab with the majority of the spray dose of the active ingredient. The lure tab is removably attached to the dispenser compartment by means of a slot 54 and hook 56 arrangement. Referring to FIG. 7, the lure tab 46 may comprise a support portion 74 and an impregnation surface 76 that is spatially offset from the support portion 74 in the direction of the aperture 44 to give the tab 46 a step-like shape. The offset is selected to ensure that substantially all of the spray dose that is emitted from the nozzle 64 impregnates the impregnation surface 76.

The material to be used for the lure tab 46 is a function of the maximal surface saturation and release rate of active ingredient from the lure tab. In the preferred embodiment, rigid polyethylene having surface pores of 50-60 microns is used. It is also contemplated that the lure tab may be of a honeycomb or 3D mesh or reticulated structure to enhance the absorption and to slow the release rate of the active ingredient from the tab.

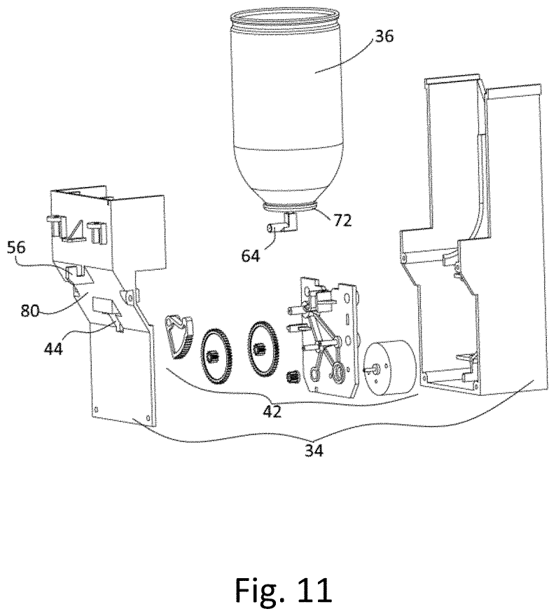

As illustrated in FIG. 11, the dispenser compartment 34 has a front surface 78 facing towards the cavity 24 in which the trapping media 26 is disposed. The front surface 78 includes an inclined portion 80 that is provided with the aperture 44 and that carries a proximity sensor 82. The inclined portion 80 allows the lure tab 46 to be mounted in close proximity to the aperture 44. The proximity sensor 82 is mounted near the aperture 44 to detect the presence of a supply of the active ingredient, for example, the presence of a spray. The sensor 82 can also be used to verify the amount of spray emitted with each dose. The sensor 82 communicates with a microcontroller 88 on the printed circuit board 38 allowing the remote monitoring of the condition of the canister, for example reporting when it is empty.

A metered dose of spray is emitted from the nozzle 64 under the operation of the nozzle actuation mechanism 42. The metered dose may be predetermined as a standard dose amount, or the amount emitted at a given time may be controlled remotely through the communications module 40.

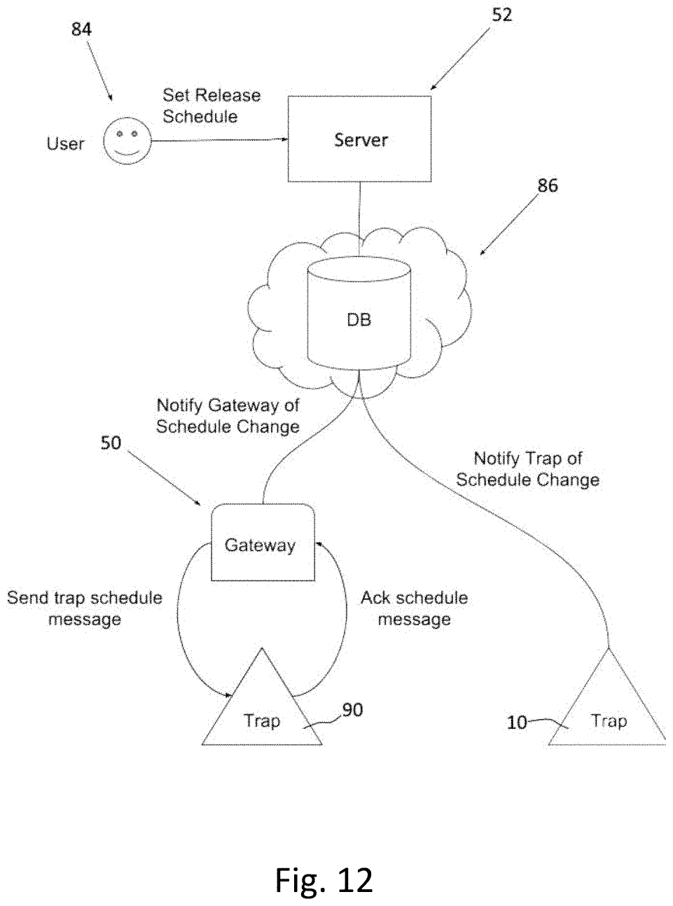

As illustrated in FIG. 12, an operator 84 remotely sets the active ingredient metered release schedule using a user interface residing on a server or application 52. The schedule may be stored in a database 86. The release schedule is sent directly to the trap 10 or via a gateway 50 on a scheduled basis or upon request of the operator. The schedule is referred to by the microcontroller 88 to communicate an ingredient release signal to the actuation mechanism 42 to cause the dispenser to spray a metered dose of the active ingredient in accordance with the schedule. Alternatively the operator 84 may cause the server 52 to issue a wireless command for the actuation of a single sprayed dose of the ingredient. The command is received by the communications module 40 in the trap 10.

As is known, a local gateway 50 may collect shorter range wireless signals from a plurality of proximate traps 90, 92. The gateway 50 may have greater power capacity than the traps, for example being power by solar arrays, and may communicate wirelessly over long distances.

Compared to the industry standards using passive lures, the remotely controlled arthropod trapping apparatus with the lure tab according to the invention displays a more consistent release rate over time, resulting in different pest counts than using the prior art approaches.

The apparatus of the invention allows for a remarkable degree of control over the use of active ingredients and the collection of metrics relating to arthropod density and behavior. By further taking into account the remote imaging capabilities of the apparatus, feedback is available to determine whether the appropriateness of the metered release schedule, its effectiveness and to vary the release protocols for different purposes.

The release protocol is typically communicated wirelessly to the trap and is a function of parameters such as the type of arthropod to be monitored, the time of day, season, environmental factors such as wind, humidity and temperature and the type of behavior to be monitored. According to such parameters, a scheduling protocol for the aerosol dosing is determined and communicated to the trap, or individual doses are triggered by individual wireless control from the server 52.

An example of the aerosol release schedule for targeting the navel orangeworm in a pistachio grove could include: every 60 minutes from March 1 to November 15 from 5 AM to 5 PM, with images being captured every 5 hours. The schedule is downloaded to the controller in the trap as opposed to triggering each release and each image capture remotely.

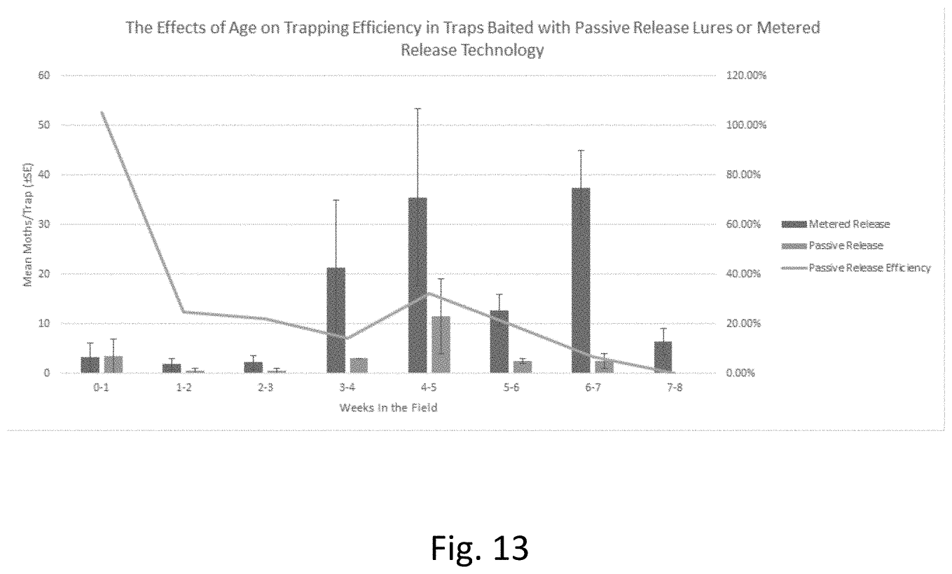

The effectiveness of metered aerosol doses impregnating an effective point source on a lure tab according to the preferred embodiment, as compared to prior art standard lure technologies (“passive release lures”) where an impregnated element is left to vaporize its lure over time, is illustrated in FIG. 13. The capture rates in a first period from 0 to 3 weeks show a relatively constant capture rate for moths for the metered releases according to the invention while the passive release captures drop off considerably. In a more intense period of moth activity beginning at weeks 3-4, the system of the invention continued to record significant captures while the passive release technology eventually (at weeks 7-8) failed to record any captures at all. The passive release efficiency is also illustrated in the graph, showing a rapid decline in its efficiency. This indicates that the aerosol periodic metered releases according to the invention are notably more effective over a period of time than the prior art passive release systems.

In the foregoing description, exemplary modes for carrying out the invention in terms of examples have been described. However, the scope of the claims should not be limited by those examples, but should be given the broadest interpretation consistent with the description as a whole. The specification and drawings are, accordingly, to be regarded in an illustrative rather than a restrictive sense.

1. An arthropod trap comprising:
an enclosure forming a cavity within the enclosure and openings in said enclosure enabling arthropods to access the cavity;
a dispenser configured to store and dispense an active ingredient comprising an arthropod lure,
an actuation mechanism for actuating the emission of a dose of the active ingredient from the dispenser, wherein the mechanism is configured to receive an active ingredient release signal from a controller within said housing;
a trapping media for trapping arthropods;
imaging apparatus positioned with the enclosure for imaging said trapping media; and,
a wireless communications module enabling wireless communication between the trap and a remote server and configured to receive instructions for the release of an active ingredient;

2. The trap of claim 1 wherein said dispenser is a pressurized aerosol dispenser and said emission is a spray.

3. The trap of claim 1 wherein said dose is a predetermined metered dose.

4. The trap of claim 1 further comprising a removable tab that is aligned with, and disposed sufficiently close to, a nozzle of said dispenser so as to be impregnated with substantially all of said active ingredient emitted from the dispenser.

5. The trap of claim 4 wherein said dispenser is a pressurized aerosol dispenser.

6. The trap according to claim 5, wherein the dispenser is mounted within said housing such that a nozzle of said dispenser is located at a lower extremity of said dispenser.

7. The trap of claim 5 wherein said actuation mechanism is for actuating a spray of said dose according to one of:
said schedule; and,
a command received from said communications module.

8. The trap according to claim 1 further comprising a sensor for detecting the presence of a spray from said dispenser.

9. The trap according to claim 5 wherein a compartment housing said dispenser includes an aperture through which said spray may pass, and an inclined surface for mounting said tab on said inclined surface.

10. The trap according to claim 5, wherein said tab is porous or has a 3D mesh-like or reticulated structure.

11. The trap according to claim 5 wherein the lure tab has a step-like shape.

12. A method of causing the emission from a trap of an active ingredient affecting the behavior of arthropods comprising:
providing said trap having an aerosol dispenser and an actuating mechanism configured to cause the dispenser to spray a
predetermined dose of said active ingredient within said trap with each spray;
said dispenser being configured to actuate a spray in response to one of:
a signal from a controller located within said trap said controller generating said signal according to a schedule received from a wireless communications module located in said trap; and,
a wireless signal received by said communications module within said trap; and,
periodically imaging a sticky media within said trap and wirelessly communicating the resulting images to a remote server or application.

13. The method of claim 12 wherein said schedule is created as a function of a parameter selected from among the group of parameters comprising: a species of arthropod of interest, a time of day, a season, environmental factors, a type of said active ingredient, an active ingredient present in the environment, an assessment of images received from said trap as a result of the operation of another schedule.

14. The method of claim 12 further comprising the step processing said resulting images to derive an arthropod count.

15. The method of claim 12 further comprising directing said dose by spray to a tab, substantially all of said dose being impregnated on said tab.

16. The method of claim 14 wherein said step of processing is conducted by said server or application.

17. The method of claim 14 further comprising the step of making an agronomic decision as a function of said count.

18. The method of claim 16 where said decision comprises spraying a pesticide.

19. An arthropod trap comprising:
a housing, said housing comprising:
an enclosure and access openings;
a trapping media within the enclosure;
imaging apparatus for imaging the media;
a power unit;
a communications module enabling wireless communication between the trap and a remote server;
an aerosol dispenser equipped for remote metered dose actuation, said dispenser being mounted upside down, with a nozzle at a lower extremity of the dispenser and an actuation mechanism adjacent the nozzle.

20. The trap of claim 19 further comprising a tab is disposed proximal to the nozzle for receiving and being impregnated by substantially all of the aerosol dose.

21. The trap of claim 19 further comprising a controller configured to enable said trap to be operated remotely by wireless communication and to receive aerosol dose schedules and imaging schedules, said schedules being a function of parameters selected from the group comprising: a type of arthropod of interest, a time of day, a season, environmental factors, a type of active ingredient being emitted from the aerosol, a type of active ingredient present in the environment.

22. The trap of claim 19 further comprising a controller configured to enable said trap to be operated remotely by wireless communication and to receive instructions to actuate individual doses or individual image captures.
